(19) United States
(12) Patent Application Publication
(10) Pub. No.: US 2006/0179939 A1
(43) Pub. Date: Aug. 17, 2006

(54) Sensor enclosure with vestibule and opposing apertures

(76) Inventor: Landon Duval, Huntington Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/056,747

(22) Filed: Feb. 11, 2005

(51) Int. Cl. G01D 11/24

(52) U.S. Cl. 73/431

(57) ABSTRACT

A sensor element is mounted within an enclosure package, the sensor element interconnected with plural discrete conductors available for electrical interconnection exterior to the package. The package is formed with opposing panels, wherein each of the opposing panels provides an aperture for free gas flow through the package. One of the panels further provides an outwardly extending flange surrounding one of the apertures, thereby forming a gas vestibule adjacent to the respective aperture.

### 1. RELATED APPLICATIONS

none

### BACKGROUND OF THE INVENTION

1. Field of the Invention

This invention relates generally to the encapsulation and general enclosure of solid state devices, and more particularly to a sensor package with specific configuration for improved sensing of components of vapors released in proximity to a solid state sensor therewithin.

2. Description of Related Art

The following references define the present state of this field and are hereby incorporated herein by reference:

Product Information sheet published by Figaro USA, Inc. for a packaged sensor model number TGS2620.

Pawluczyk, U.S. 2003/0120137, discloses an invention that provides an apparatus for measurement of Raman scattered radiation comprising. The apparatus comprises at least one source of electromagnetic radiation for producing an electromagnetic radiation beam characterized by a narrow spectral width, an integrating cavity having an interior and an exterior, wherein a sample is placed in said interior. The integrating cavity further having at least one port for insertion of the sample in the interior and for transmission of the electromagnetic radiation into and out from the interior, the at least one port extending from the exterior to said interior of said integrating cavity. The integrating cavity also comprises a first optical element for transmitting the electromagnetic radiation into the interior of the integrating cavity through the at least one port, and a second optical element for collecting Raman scattered electromagnetic radiation from the sample through the at least one port.

The apparatus also comprises a spectrum analyzer for determining spectral composition of the Raman scattered electromagnetic radiation, a detector for measuring the Raman scattered electromagnetic radiation; and a system for determining concentration of at least one chemical compound from the measured Raman scattered electromagnetic radiation. The apparatus may also comprise a radiation expanding element. A method for measuring the concentration of one or more chemical compounds in a sample using Raman scattering is also provided.

Rosenthal et al., U.S. Pat. No. 5,086,229, discloses near-infrared quantitative analysis instruments and methods that non-invasively measure blood glucose by analyzing near-infrared energy following interactance with venous or arterial blood, or transmission through a blood containing body part. The instruments and methods are accurate and readily lend themselves to at-home testing by diabetics.

Braig et al., U.S. Pat. No. 5,313,941, discloses a method and apparatus for monitoring glucose, ethyl alcohol and other blood constituents in a noninvasive manner. The measurements are made by monitoring infrared absorption of the desired blood constituent in the long infrared wavelength range where the blood constituent has a strong and distinguishable absorption spectrum. The long wavelength infrared energy is passed through a finger or other vascularized appendage and the measurement made. To prevent the high energy source from burning or causing patient discomfort, only short bursts or pulses of energy are sent through the finger with a very low duty cycle and low optical bandwidth. The bursts are further synchronized with systole and diastole of the cardiac cycle so that only two pulses are sent per heart beat, one during diastole and one during systole. The detection signals measured during application of these bursts of energy are then used to calculate the concentration of the blood constituents in accordance with a polynomial equation.

Hall et al., U.S. Pat. No. 5,361,758, discloses a non-invasive device and method for monitoring concentration levels of blood and tissue constituents within a living subject such as a human or animal that utilizes a polychromatic light source that emits light over a broad spectrum of wavelengths in the near infrared range. The light is passed through, or reflected from, a part of the subject such as a finger, ear lobe or other part of the body. That light is then separated into its various components by means of a grating or prism, and the near infrared band is focused onto a linear array detector. A microprocessor uses the output of the array detector to measure the light transmitted (T), calculate the absorbance (log 1/T) and calculate the second derivative of the absorbance. A calibration equation is used for each constituent to be monitored to convert the second derivative measurements to a concentration level for that constituent. The device is programmed to take measurements between heart beats and to adjust for the temperature of the sample being taken. The device can be used to determine levels of various blood and tissue constituents, including glucose, cholesterol, alcohol, blood gases and various ions. The device is simple to use, painless and does not cause any physical discomfort, skin irritation or present any risk of infection to the user. The device can be used for clinical use or for home use and the memory of the microprocessor can be used to assist with record keeping and with dosage calculations. Previous non-invasive devices are not sufficiently accurate or convenient to use to replace the invasive testing systems presently used.

Cadell et al., U.S. Pat. No. 5,429,128, discloses a finger receptor that is used with a non-invasive monitoring device to determine non-invasively the concentration of known constituents in blood or tissue. The receptor has a channel for receiving a finger of a user. The channel has a light entrance and a light exit so that light can be passed from a light source through a finger located in the channel in a direction generally normal: to the finger. Extraneous light is excluded and the finger is held in position by a spring-mounted roller. The receptor has sensing means to determine when a finger has been properly positioned in the channel. Previous devices are not capable of achieving repeatable results to a sufficient degree to replace invasive methods of testing.

Steinberg, U.S. Pat. No. 5,743,349, discloses a vehicle ignition interlock system including a non-invasive reader of a person's blood-alcohol concentration in combination with ignition interlock circuitry that prevents operation of a vehicle by an intoxicated person. The non-invasive blood-alcohol concentration reader, termed alcoh-meter, utilizes optical spectroscopic electromagnetic radiation technology to determine the alcohol levels in the blood. The alcoh-meter is preferably a dash mounted sensor for receiving a person's finger and absorbing incident light from a multiple wavelength light source and causing a light absorption reading to be generated based on the person's blood alcohol concentration in the finger tissue. After registering a reading, the results are compared electronically against a table of impaired/non-impaired levels of blood alcohol concentration. The impaired/non-impaired results are communicated to interlock circuitry that either enables, or disables start-up of the vehicle. If an impaired status is determined, the results are displayed instructing the operator to wait, or find a non-impaired operator.

Aldrich, U.S. Pat. No. 6,064,898, discloses a non-invasive blood component analyzer using spectrophotometry, with systole/diastole corrections for tissue absorbance, and with built-in monitoring of light path length to allow its accurate use in subjects with widely varying finger size and/or varying pulse amplitude. Blood components that are able to be analyzed include oxy-hemoglobin, total hemoglobin, bilirubin, glucose, hormone levels and a variety of drugs.

Yang et al., U.S. Pat. No. 6,167,290, discloses a method and apparatus for non-invasively measuring animal/human blood glucose and other metabolites including an excitation laser source, a negative pressure based sampling port which interfaces to a human or other animal tissue sample in vivo, a Raman spectrometer, and data analysis and display devices. The device can be made in a compact size and may be portable, and it can be used in homes, offices or clinics. A negative atmospheric sampling port is made of a vacuum chamber that is connected with an electrically or manually driven vacuum pump which creates a negative air pressure inside the vacuum chamber. Under the negative air pressure, a substantial amount of blood is “sucked” into a small area of the human finger so that measurement of an enhanced Raman signal can be made.

Edmonds, III et al., U.S. Pat. No. 6,229,908, discloses a method and an ignition interlock for preventing operation of equipment when an operator's blood-alcohol content is above a threshold value. The interlock has a blood-alcohol detector that measures intensities of wavelengths of light emerging from a finger. A microprocessor correlates these intensities with the finger's blood-alcohol content, determines whether this content is above a threshold level, and prevents the equipment from operating unless the blood-alcohol content is below the threshold. The interlock also has a fingerprint image generator which reflects light of the finger and scans the fingerprint to form a scanned image. The microprocessor compares this scanned image to a prestored image of a principal operator and compares the two images to determine whether the images match. The fingerprint and blood-alcohol analyses occur substantially simultaneously.

Floyd, U.S. Pat. No. 6,614,920, discloses a fingerprint entry and engine starting system, including a computerized video recorder, and transmitter that is installed in a driver's door of a vehicle housing a transparent shield. The recorder is perpendicular via position under this transparent shield. Since this shield is installed in the vehicle's door handle, a legal user will press the shield upon its left side portion, such as to start the vehicle's engine. As a result, whenever the right hand portion upon the shield is pushed by a legal user, the vehicle's door-locks are freed. This is done when the recorder is actuated whereas a fingerprint of a user is transformed from optical information to computer data when the shield is pressed. This data is transmitted and compared with preset data, such that when this preset data stored in a memory matches with transformed data, coils via actuators for releasing the vehicle's door-locks are actuated. An ignition switch actuates a motor of an engine starter also, as a match is defined, which drives the starter and starts the engine of the vehicle. This is accomplished, when an activating signal is outputted from a CPU. This CPU defines the memory whereby outputting the activating signal only, whenever the shield is pushed by a legal user for actuating two pushbutton switches. Four fingerprint input pushbutton switches outwardly upon the door causes one power window, a heater, a trunk and a hood to be operated also, before entering the vehicle without a key.

However, the TGS2620 fails to teach that a vestibule may be formed on the package for improved capture of skin released vapors, or that a vent hole may be placed in opposition to a vent screen of the TGS2620 to improve the flow of vapors through the sensor thereby improving sensor initiation time and output signal strength. The present invention fulfills these needs and provides further related advantages as described in the following summary.

### SUMMARY OF THE INVENTION

The present invention teaches certain benefits in construction and use which give rise to the objectives described below.

In one of the best mode preferred embodiments of the present invention, a sensor element is mounted within an enclosure package, the sensor element interconnected with plural discrete conductors available for electrical interconnection exterior to the package. The package is formed with opposing panels, wherein each of the opposing panels provides an aperture for free gas flow through the package. One of the panels further provides an outwardly extending flange surrounding one of the apertures, thereby forming a gas vestibule adjacent to the respective aperture. The invention is able to sense chemical species in general and ethanol vapors more specifically to determine that such chemical species is present, which then triggers a sensing circuit to enable monitoring and remedial actions such as audible alarm and electrical signal production. The present is specifically of use in sensing ethanol vapors emitted by the hand or fingers of a person in close proximity to the sensor, and more particularly having a skin portion in contact with the sensor package. However, further uses may be found in general vapor and gas sensing of chemical partial pressures, ions and chemical species of particular interest. The vestibule enables concentrations of such gaseous species to more favorably affect the sensing element, and it has been found that the specific combination of the vestibule and the dual apertures within the enclosure work synergistically to provide a very significant improvement in sensing vapors from a skin surface in contact or near contact with the vestibule.

A primary objective of the present invention is to provide an apparatus and method of use of such apparatus that yields advantages not taught by the prior art.

Another objective of the invention is to improve the capture of vapors formed in and adjacent to skin surfaces.

A further objective of the invention is to improve the flow of vapors given off by the skin into an enclosure for sensing partial pressures of selected vapors and gases.

A still further objective of the invention is to provide an enclosed space or vestibule for receiving skin vapors directly from the skin with minimal dilution by the surrounding environment.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a bottom perspective view of one embodiment of the present invention showing a lower aperture therein;

FIG. 2 is a top perspective view thereof showing an upper aperture therein;

FIG. 3 is a sectional view taken along line 3-3 in FIG. 1;

FIG. 4 is a sectional view taken along line 4-4 in FIG. 2; and

FIG. 5 is an electrical schematic diagram of the invention as biased by an external resistor.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

In a preferred embodiment of the present invention a sensor apparatus comprises a sensor element 10, which may be any sensor, mounted within an enclosure package 20 which may be similar to a TO-5 metal can, for instance. However, the sensor element 20 may be mounted in any package whatsoever. In one embodiment, the sensor element 20 is highly sensitive to alcohol solvent vapors and in particular, to ethanol (ethyl alcohol) vapor in air. Such a sensor element 10 is manufactured by Figaro USA, Inc. of Glenview, Ill. as sensor model number TGS 2620. However, the sensor element 10 may be any sensor for sensing any particular gaseous species of choice. In this description the Figaro device shall be used as an example, but it should be held in mind that this is merely one example out of many that might be used to achieve the novelty and enablement of the present invention.

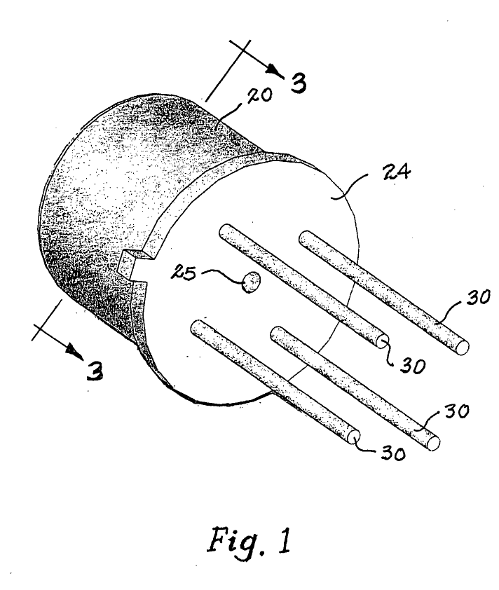

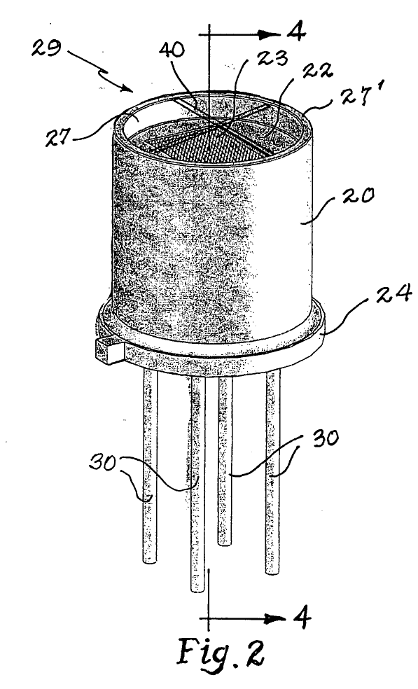

Therefore, the Figaro sensor element 10 is interconnected with plural discrete conductors 30. The conductors 30 extend from the sensor element 10 through a base structure referred to herein as panel 24 and are thereby accessible for electrical interconnection exterior to the package 20 as would be the typical case when the conductors 30 are designed for inserted into a printed circuit board for surface mounting to a circuit substrate. This is well known in the art. The package 20 is formed with opposing panels or surfaces that are in general opposing juxtaposition such as the base panel 24, as best seen in FIG. 1, and the top panel 22 as best seen in FIG. 2. These panels 22 and 24, or surfaces, provide aperture 23 and 25 respectively so as to enable free gas flow through the package 20. In the top panel 22 of the TGS 2620 device a relatively large screened aperture allows gases and vapors to come into contact with the sensor within the TO-5 can. However it does not provide an opening in the base panel 24 so that free flow of air and vapors or gases cannot readily move through the device. Movement of the molecules of partial pressure gases arrive at the sensor in the TGS 2620 primarily by diffusion. Therefore, the sensing of ethanol vapors is drastically enhanced in the present invention by permitting free air flow through the package 20 so that chemical species can move into contact with the sensing element 10 by convention motion.

Preferably, the enclosure package 20 is cylindrical as shown in FIGS. 1 and 2, (but clearly may be of any shape), with the opposing end panels 22 and 24 located at opposing ends of the cylindrical shape, but such panels may have any physical relationship to each other. However, the apertures 23 and 25 should sandwich the sensor element 10 therebetween, so that gas is able to flow directly into contact with the sensor element 10.

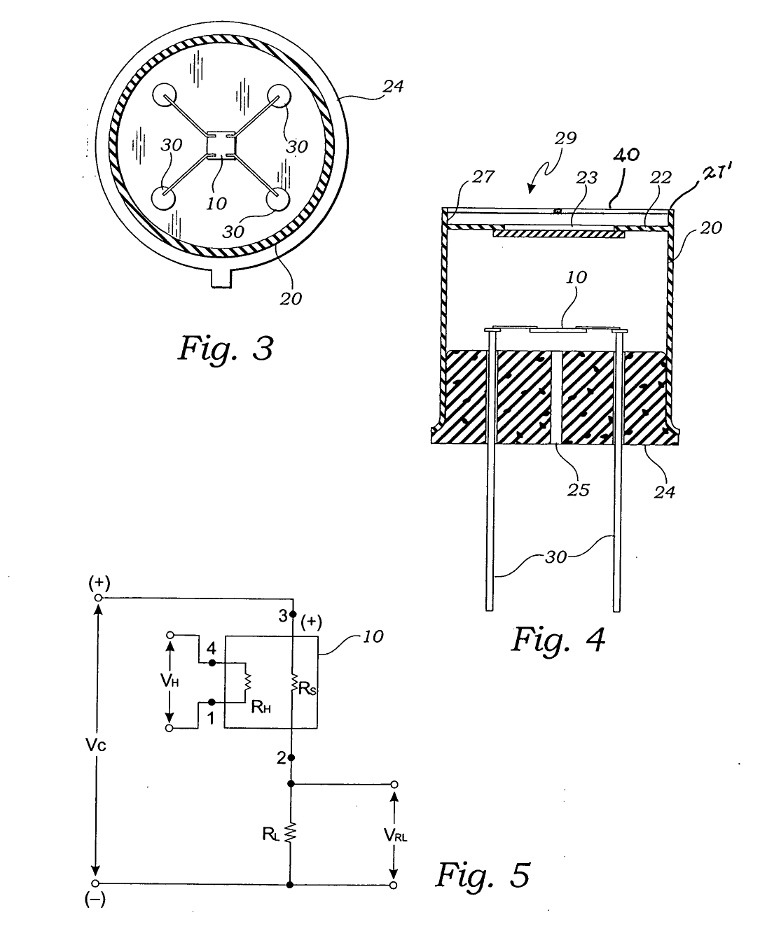

Preferably, the sensor element 10 is positioned in an axial-centric position, as shown in FIG. 3, within the package 20 so as to receive optimal contact with gas flowing through the enclosure package 20.

Preferably, one of the apertures 23 covers an appreciable portion of its corresponding panel 22, and wherein a further one of the apertures 25 comprises a round hole of diameter between approximately 0.8 mm and 1.6 mm in a TO-5 size can. For this size can, the round hole 25 must be between the 0.8 and 1.6 mm diameter in order to function effectively. A smaller hole diameter diminishes the sensitivity of the invention and a larger hole tends to cool the sensor 10 too much for reliable and repeatable operation. For cans of different size and volume, the openings would be appreciably different but the same principles would apply.

Preferably, one of the panels 22 further provides a flange 27 extending outwardly from the one of the panels 22, the flange 27 surrounding the one of the apertures 22, thereby forming a gas vestibule or chamber 29; a set volume enclosable, for instance, by placing a finger surface in contact with the flange, within which the one of the apertures 22 resides. This vestibule 29 plays and important part in the use of the present invention. As shown in FIG. 2, one or more wires 40 may be engaged adjacent an outwardly facing edge 27′ of the flange 27. Such wires 40 enable a finger's surface to close the vestibule 29 without appreciably diminishing its volume by entering the vestibule 29. Therefore, by knowing the volume of the vestibule 29 quantitative analysis is enabled of the chemical composition of the gases within the vestibule and the enclosure 20. The wires 40 may be replaced by a screen or other means for preventing a finger from entering the vestibule 29 without appreciably reducing the skin surface exposed to the vestibule 29.

In applications where it is desired to detect ethanol vapors that are evaporated from or which exude from the skin, as with the skin of the human hand or fingers, the present invention may be placed such that the hand or one or more fingers comes into contact or near contact with the invention vestibule. This situation may arise in the use of an automobile or truck when the hand contacts a steering wheel or gear shifting device. When this occurs it is found that by providing vestibule 29 on the top panel 22 and by placing the vestibule level with a surface and covering it with a hand sensitivity of the invention is significantly improved. In this description and in the attendant claims the use of the word “hand” shall be taken to mean any portion of the human hand such as the palmer portion or one or more fingers of the hand, but not limited thereto.

FIG. 5 depicts the preferred embodiment of the invention in an electrical schematic. In the preferred embodiment, i.e., when the Figaro USA, Inc. sensor model TGS 2620 is used, the sensor 10 requires two voltage inputs: heater voltage VH and circuit voltage VC. The heater voltage VH is applied to an integrated heater RH in order to maintain the sensor 10 at an optimal sensing temperature. Circuit voltage VC is applied to allow measurement of voltage VRL across a load resister RL which is connected in series with sensor 10. A common power supply circuit can be used for both VC and VH to fulfill the sensor's electrical requirements. The value of the load resistor RL should be chosen to optimize the alarm threshold value, keeping the power consumption of the semiconductor below a limit of 15 mW. Power consumption is highest when the value of RS is equal to RL on exposure to gas. Points 1, 2, 3 and 4 in the schematic refer to the four lead wires 30. In this configuration Vc and VH are both about 5 VDC. RS is between 1 and 5 kilohms in the presence of 300 ppm elthanol in air. RH is about 83 ohms at room temperature. RL is a variable resistor at 450 ohms minimum.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A sensor apparatus comprising: a sensor element mounted within an enclosure package, the sensor element interconnected with plural discrete conductors, the conductors extending from the sensor element through the package for electrical interconnection; the package providing an aperture enabling free gas flow into the package; and a flange extending outwardly from the package, the flange surrounding the aperture, thereby forming a gas vestibule inclusive of the aperture.

2. The apparatus of claim 1 wherein the enclosure package is cylindrical, the sensor element and the aperture are both positioned axial-centric to enable axial gas flow into the package and across the sensor element.

3. The apparatus of claim 1 wherein the flange extends outwardly from the package by from 1.5 mm to 2.5 mm.

4. The apparatus of claim 1 wherein the flange appreciably defines the size of the first aperture.

5. The apparatus of claim 1 further comprising at least one wire engaged across the gas vestibule in a position for inhibiting entry of a finger into the vestibule.

6. A sensor apparatus comprising: a sensor element mounted within an enclosure package, the sensor element interconnected with plural discrete conductors, the conductors extending from the sensor element through the package for electrical interconnection; the package providing plural apertures enabling free gas flow through the package; and a flange extending outwardly from the package, the flange surrounding at least one of the apertures, thereby forming a gas vestibule inclusive of the at least one of the apertures.

7. The apparatus of claim 6 wherein the at least one aperture comprises two apertures, a first one of the two apertures positioned within the gas vestibule, and a second one of the two apertures in spaced apart relationship relative to the first one of the apertures such that the sensor element is between the first and second ones of the apertures.

8. The apparatus of claim 7 wherein the enclosure package is cylindrical, and the sensor element is positioned axial-centric and the apertures are positioned and formed in opposing end panels of the cylindrical package to enable axial gas flow through the enclosure package and across the sensor element.

9. The apparatus of claim 7 wherein one of the apertures comprises a round hole of diameter between approximately 0.5 mm and 1.6 mm.

10. The apparatus of claim 5 wherein the flange extends outwardly from the package by from 1.5 mm to 2.5 mm.

11. The apparatus of claim 7 wherein the flange appreciably defines the size of the first aperture, wherein the flange extends outwardly from the package by approximately 2.0 mm, and wherein the second one of the two apertures is approximately 0.8 mm in diameter.

12. The apparatus of claim 6 further comprising at least one wire engaged across the gas vestibule in a position for inhibiting entry of a finger into the gas vestibule.
